(19) United States
(12) Patent Application Publication
(10) Pub. No.: US 2025/0205682 A1
(43) Pub. Date: Jun. 26, 2025

(54) METHOD FOR PREPARATION OF THE GRANULATED SORBENT FOR RECOVERING LITHIUM FROM LITHIUM-CONTAINING BRINES

(71) Applicant: JOINT STOCK COMPANY "AXION – RARE AND NOBLE METALS", Moscow (RU)

(72) Inventors: Dmitrii Alekseevich KONDRUTSKII, Moscow Region (RU); Gadzhi Rabadanovich GADZHIEV, Moscow Region (RU)

(21) Appl. No.: 18/690,759

(22) PCT Filed: Sep. 2, 2022
(86) PCT No.: PCT/RU2022/050277

§ 371 Date: Mar. 11, 2024

(30) Foreign Application Priority Data
Sep. 12, 2021 (RU) 2021126786

(51) Int. Cl. B01J 20/30; B01J 20/04; B01J 20/28

(52) U.S. Cl. CPC B01J 20/3007; B01J 20/041; B01J 20/046; B01J 20/28004; B01J 20/28019; B01J 20/3071; B01J 20/3078

(57) ABSTRACT

The invention relates to the field of obtaining inorganic and organoelement sorbents. The proposed method comprises obtaining a chlorine-containing modification of aluminum lithium double hydroxide (DHAL-Cl) from a solution of aluminum chloride, comprising lithium, with addition of sodium hydroxide to control pH. The obtained DHAL-Cl is mixed with the polyvinyl alcohol aqueous solution instead of separating from the reaction mixture. Resulting product is dried to a paste-like state and extruded. The extrudate is pelletized for forming a rounded shape of the granules, the granules are heat-treated, and their color changes from white to black. Prior to the use the sorbent is washed with water. The technical result is providing a production method for a sorbent having increased capacity and high mechanical strength.

The invention relates to the field of obtaining inorganic and organoelement sorbents containing aluminum, to selectively recover lithium from natural brines and technogenic chloride salines containing lithium.

At present, sorbents based on a chlorine-containing modification of aluminum lithium double hydroxide (DHAL-Cl) are considered the most promising for lithium recovery due to the availability of raw materials for their production and environmental compatibility of use. The proposed methods for their preparation, including granulation with organic binders, have both their inherent advantages and their own disadvantages.

There is a known method for producing a granular sorbent to recover lithium from lithium-containing solutions, wherein a chlorine-containing modification of aluminum lithium double hydroxide LiCl 2Al (OH)₃ nH₂O is obtained from an aluminum chloride solution pre-mixed with lithium hydroxide or lithium carbonate at an atomic ratio of Al:Li in the range from 2.0 to 2.3, when NaOH is added to the mixed solution to reach pH of 6-7. The resulting slurry of LiCl 2Al (OH)₃ nH₂O is separated from the solution, dried, ground to a particle size of less than 0.1 mm and granulated with adding polyvinyl chloride and methylene chloride as a solvent with the recovery of methylene chloride evaporating during the granulation process and recirculating it to the manufacturing process (RU 2455063, Oct. 7, 2012). The disadvantage of this method is that filtration equipment is required to separate the difficult-to-filter DHAL-Cl precipitate from the mother liquor; two-fold drying is necessary (for the DHAL-Cl powder before granulation and for the granules after granulation); toxic and environmentally hazardous solvent methylene chloride is to be used, which deteriorates sanitary and hygienic conditions at epy manufacturing site; and expensive and difficult to operate solvent recovery system is required.

A method is known for preparing a lithium adsorbent granulated in the absence of any binder based on LiCl 2Al (OH)₃ nH₂O, with n being comprised between 0.01 and 10, the method includes mixing in an aqueous medium, at least one source of alumina and at least one source of lithium in order to obtain a suspension, filtering the resulting suspension obtained for obtaining a slurry, followed by drying the obtained slurry at a temperature between 20 and 80° C. for a period between 1 h and 12 h, then granulating by extrusion the resulting dried slurry, and then the drying of the obtained extrudates at a temperature comprised between 20 and 200° C. for a period between 1 hour and 20 hours, in order to obtain the crystallized solid material of formula LiCl 2Al (OH)₃ nH₂O (US 2016/0317998 A1, Mar. 11, 2016). The disadvantage of this method is that filtration equipment is required to separate the hard-to-filter DHAL-Cl slurry from the mother liquor, the low mechanical strength of the obtained adsorbent granules and their low durability due to shedding of the granules during operation due to the lack of a binder.

The closest in terms of technical essence and the achieved result is a method for obtaining a granular sorbent for lithium recovery, the method including obtaining a powder of a chlorine-containing modification of aluminum lithium double hydroxide (DHAL-Cl) from a solution of aluminum chloride containing lithium with an AlCl₃ concentration of 45-220 kg/m³, comprising lithium in the form of compounds LiCl, Li₂CO₃, LiOH H₂O, or in the form of mixtures of these compounds, with an atomic ratio of Al:Li in the range from 2,0 to 2,3, with addition of sodium hydroxide to the pH of the mixed solution 6-7, separation of the DHAL-Cl powder from the solution, pulping DHAL-Cl slurry, secondary filtration of DHAL-Cl, two-stage drying of the DHAL-Cl powder to the residual moisture content of DHAL-Cl between 1.5 and 2.0 wt. %, powder grinding to particle size of ≤0.10 mm, granulation of the powder with the addition of chlorinated polyvinyl chloride and a organochlorine solvent by extrusion through dies with a diameter of 5 mm, removal of the chlorine-containing solvent with a hot air stream, grinding the extrudate, screening fith selection of the fractions no less than 1.0 mm and no more than 2.0 mm, drum rolling, giving the granular sorbent a rounded shape of the granules. Organochlorine solvent and water vapors are condensed from the cooled air stream (RU 2657495, Jun. 14, 2018)

The main disadvantages of the known method are the reduced capacity of the resulting sorbent obtained, associated with blocking of the active sorption centers of the material (DHAL-Cl) by a layer of non-polar polymer (chlorinated PVC), which is poorly wettable by water and aqueous salines; filtration equipment is required to separate the hard-to-filter slurry of DHAL-Cl from the mother liquor; double drying and removal of the organochlorine solvent is required; toxic and environmentally hazardous chlorine-containing solvents (methylene chloride) are used, which deteriorates sanitary and hygienic conditions at the manufacturing site; the solvent recovery system is expensive and difficult-to-use.

The object of the present invention is to provide a workable method for obtaining a granulated sorbent for lithium recovery from the lithium-containing brines.

This object is solved by the described method of obtaining a sorbent for lithium recovery from lithium-containing brines, the method comprising:
obtaining a chlorine-containing modification of aluminum lithium double hydroxide (DHAL-Cl) from a solution of aluminum chloride with an AlCl₃ concentration of 45-220 kg/m³, comprising lithium with an atomic ratio of Al:Li of 2.0-2.3:1, with addition of sodium hydroxide to the pH of the mixed solution, wherein the pH of the mixed solution is 4-5,
wherein instead of separating the DHAL-Cl slurry from the solution followed by its drying, the DHAL-Cl slurry is mixed with a polyvinyl alcohol aqueous solution in an amount of 10-15 wt. % (in terms of polyvinyl alcohol) by weight of DHAL-Cl,
well stirring the mixture at a temperature of 60-80° C. until a smooth mass is obtained,
drying the mixture to a paste-like state and extruding,
pelletizing the extrudate forming a rounded (spherical) shape of the granules,
heat-treating the granules at 105-120° C. for 12-24 hours to form an insoluble carbon frame of the sorbent having a uniformly black color.

Prior to the use for lithium sorption the granulated sorbent is washed with water, to remove sodium chloride.

Polyvinyl alcohol is preferably used in the form of a solution with a concentration of 3-5%.

The scope of the above set of features allows to achieve the technical result due to forming a three-dimensional carbon-containing skeleton during the dehydration of polyvinyl alcohol, when the process is carried out under the stated conditions, and the resulting carbon structures are hydrophilic and wettable, bind DHAL-Cl particles to each other, thus minimizing shedding and increasing mechanical strength. The combination of porosity, low weight and strength of the carbon-containing frame provides a sorbent with increased capacity.

Without limitation to a certain theory, the following mechanism can be assumed.

Polyvinyl alcohol macromolecules are distributed between the particles of the obtained DHAL-Cl at the stage of mixing the reagents at 60-80° C. During the subsequent heat treatment of the rounded granules obtained from a mixture with pH=4-5, in the presence of aluminum ions as a catalyst, the polyvinyl alcohol molecules undergo dehydration with the formation of a cross-links system between the macromolecules, as well as a system of alternating double bonds C═C inside the macromolecules, wherein water molecules are released into the gas phase during heat treatment at 105-120° C., the mass turns black and loses solubility in water and other solvents due to a three-dimensional (cross-linked) carbon-containing frame, which constitutes a system of interpenetrating pores and channels.

Unlike the prototype, the sorbent obtained in accordance with the claimed method has a free internal volume and has increased hydrophilicity due to better wettability and availability of DHAL-Cl, has a higher capacity and is less prone to shedding and grinding during operation, since DHAL-Cl bonds with the frame are more durable. The method is environmentally friendly, does not require any use of toxic organochlorine solvents.

All of the above fundamentally distinguishes the proposed sorbent and the method of its production from the sorbent and the production method known from the prototype.

Preferred process parameters are related to the following.

The most optimal pH of the mixed solution is 4-5. When pH decreases below 4, the yield of DHAL-Cl decreases and soluble aluminum and lithium salts are formed; at pH higher than 5, the pH catalytic effect on dehydration and formation of a porous carbon-containing frame decreases.

The amount of polyvinyl alcohol less than 10 wt. % based on the weight of DHAL-Cl reduces the strength of the sorbent formed during heat treatment of the matrix and does not lead to a decrease in the mechanical strength of the product, because polyvinyl alcohol is the raw material for creating the carbon-containing frame. On the other hand, an increase in the amount of polyvinyl alcohol by more than 15 wt. % based on the weight of DHAL-Cl leads to a decrease in capacity, since the content of DHAL-Cl in the sorbent matrix decreases.

The temperature of mixing the DHAL-Cl slurry with polyvinyl alcohol below 60° C. leads to an elongation of the process and worsens the degree of mixing due to an increase in the viscosity of the mixture. The temperature of mixing the DHAL-Cl slurry with polyvinyl alcohol which is higher than 80° C. is undesirable, since the incipient crosslinking processes and processes of PVA macromolecules structuring under mechanical shear conditions during mixing can lead to the formation of a friable gel-type product with low adhesion, which will have a reduced mechanical strength after extrusion and pelletizing.

Decrease of the heat treatment temperature to the value less than 105° C. leads to the formation of a three-dimensional frame which is incompletely cross-linked, which causes solubility of the resulting sorbent in water and in aqueous solutions, which is unacceptable. The heat treatment temperature of more than 120° C. leads to a decrease in the capacity of the sorbent, because the DHAL-Cl crystallizes and loses hydrated water, which adversely affects the capacity and selectivity of the sorbent.

When the heat treatment is carried out during less than 12 hours, this is not enough to form a strong insoluble carbon frame of the sorbent. On the other hand, a heat treatment for more than 24 hours is unreasonable due to the possible development of negative oxidative processes, since the heat treatment is carried out in air and the longtime exposure at the elevated temperature can lead to sorbent surface oxidation.

When the concentration of polyvinyl alcohol is less than 3%, this causes excessive watering of the mixture and requires additional costs for drying. The polyvinyl alcohol concentration of more than 5% results in deterioration in the mixing of the polyvinyl alcohol solution with the DHAL slurry due to a higher viscosity of the polyvinyl alcohol solution and causes the formation of a heterogeneous product.

A specific not limiting example is given below, only for illustration of the invention implementation.

### EXAMPLE 1

A 10 L Scheidt globe equipped with a thermocouple, a dropping funnel, a glass combined pH meter electrode and a mechanical stirrer, which is placed on a bath to maintain the temperature, was charged with 2 L of a lithium chloride solution with a lithium concentration of 5.8 g/L, and 812 g of hexaqua aluminum chloride (with the atomic ratio Al:Li of 2.0:1), and stirred up to complete dissolving of the aluminum chloride. While stirring, a solution of sodium hydroxide (6M) was added dropwise in an amount of 1.68 L, while the mixture in the retort turned white due to the formation of DHAL-Cl, with the resulting mixture pH being 4. After the dosing of the sodium hydroxide solution 1112 g of a 3% polyvinyl alcohol solution (10% in terms of PVA from the mass of LiCl 2Al(OH)₃ was charged into the retort with stirring.

After the dosing is completed, heating to 60° C. was turned on; after reaching the preset temperature, stirring was carried out until a smooth mass was obtained (1 hour). Then the mass was transferred from the retort to a baking sheet and dried in a thermostat at 80° C. to a paste-like state. The mass was extruded in a single screw extruder with a cutting knife through 3 mm diameter dies. The extrudate was transferred to a tumble pelletizer to obtain rounded particles with a diameter of 3 mm. The yield of the granulate is 1800 g. The obtained granules were heat-treated at 105° C. for 24 hours. The dried product was round black granules with a particle diameter of 2 mm and a weight of 1245 g.

### EXAMPLE 2

A 5 L Scheidt globe equipped with a thermocouple, a dropping funnel, a glass combined pH meter electrode and a mechanical stirrer, which is placed on a bath to maintain the temperature, was charged with 2 L of a lithium chloride solution with a lithium concentration of 1.01 g/L, and 162.4 g of hexaqua aluminum chloride (with the atomic ratio Al:Li of 2.3:1), and stirred up to complete dissolving of the aluminum chloride. While stirring, a solution of sodium hydroxide (6M) was added dropwise in an amount of 0.325 L, while the mixture in the retort turned white due to the formation of DHAL-Cl, with the resulting mixture pH being 5. After the dosing of the sodium hydroxide solution 174 g of a 5% polyvinyl alcohol solution (15% in terms of PVA from the mass of LiCl 2Al(OH)₃ was charged into the retort with stirring.

After the dosing is completed, heating to 80° C. was turned on; after reaching the preset temperature, stirring was carried out until a smooth mass was obtained (1 hour). Then the mass was transferred from the retort to a baking sheet and dried in a thermostat at 80° C. to a paste-like state. The mass was extruded in a single screw extruder with a cutting knife through 3 mm diameter dies. The extrudate was transferred to a tumble pelletizer to obtain rounded particles with a diameter of 3 mm. The yield of the granulate is 325 g. The obtained granules were heat-treated at 120° C. for 12 hours. The dried product was round black granules with a particle diameter of 2 mm and a weight of 241 g.

The sorbent obtained was tested and respective characteristics are presented below.

### A. Determination of the Sorbent Lithium Holding Capacity

Tests of the sorbents obtained according to the Examples 1 and 2 were carried out under static conditions for the sorption of lithium from a brine of the following ionic composition, g/l: lithium Li⁺—0.437; sodium Na⁺—114.55; potassium K⁺—9.1; chlorine Cl⁻—196.0; magnesium Mg²⁺—3.56; calcium Ca²⁺—1.73; sulfates (SO₄²⁻)—6.51.

Prior to the testing, the sorbent was washed with water on a Buchner funnel to remove sodium chloride to a concentration lower than in the initial solution used for sorption and to release the capacity for lithium. The water consumption for washing was 10 volumes. After washing with water, the moisture content of the sorbents was determined according to GOST 10898.1-84 during drying at a temperature of 80° C. The moisture content of the sorbent according to the Examples 1 and 2 is 50 and 41 wt %, respectively.

Lithium capacity tests were carried out under static conditions according to the following procedure. A portion of the sorbent weighing 5.0 g was placed in a conical Erlenmeyer flask with a volume of 250 ml and filled with 100 ml of brine of the above composition, and then it was continuously stirred for 24 hours. The sorbent granules were separated on a paper filter, and the solution was analyzed for the residual lithium content. The residual lithium concentration in the solution was 0.197 and 0.199 g/l, respectively, for the sorbents obtained according to the Examples 1 and 2.

The lithium capacity of the sorbent was calculated using the formula described in GOST 20255.1-84.

The capacity of the sorbent, determined under static conditions, for lithium from the Example 1 was 9.6 g/l, from the Example 2-8.1 g/l, which is 1.3-1.6 times better than for the sorbent according to the prototype (5.9-6.2 g/l).

### B. The Determination of the Sorbents Mechanical Strength Carried out According to OST 95.291-86

Tests showed that the mechanical strength of the sorbent obtained according to the Example 1 was 99%, according to the Example 2-99.5%.

Thus, the studies carried out have shown that the sorbent obtained in accordance with the claimed method provides increased capacity when extracting lithium from solutions, and the sorbent obtained under the claimed method has high mechanical strength. The method is characterized by manufacturability and allows obtaining a sorbent in the form of mechanically strong granules.

1. A method for obtaining a granulated sorbent for lithium recovery from lithium-containing brines, the method comprising:
obtaining a chlorine-containing modification of aluminum lithium double hydroxide (DHAL-Cl) from a solution of aluminum chloride with an AlCl₃ concentration of 45-220 kg/m³, comprising lithium with an atomic ratio of Al:Li of 2.0-2.3:1, with addition of sodium hydroxide to the pH of the mixed solution,
characterized in that
the pH of the mixed solution is 4-5,
instead of separating the obtained DHAL-Cl slurry from the reaction mixture followed by its drying, the DHAL-Cl slurry is mixed with the polyvinyl alcohol aqueous solution in an amount of 10-15 wt. % (in terms of polyvinyl alcohol) by weight of LiCl·2Al(OH)₃,
well stirring the mixture at a temperature of 60-80° C. until a smooth mass is obtained,
drying the resulting mixture to a paste-like state and extruding,
pelletizing the extrudate forming a rounded (spherical) shape of the granules,
heat-treating the granules at 105-120° C. for 12-24 hours to form an insoluble carbon frame of the sorbent having a uniformly black color;
washing the granulated sorbent with water prior to its use for lithium sorption, to remove sodium chloride.

2. The method according to the claim 1, wherein the polyvinyl alcohol is preferably used in the form of a solution with a concentration of 3-5%.
